(19) United States
(12) Patent Application Publication
(10) Pub. No.: US 2007/0258039 A1
(43) Pub. Date: Nov. 8, 2007

(54) Spectacle frame bridge housing electronics for electro-active spectacle lenses

(76) Inventors: Dwight P. Duston, Laguna Niguel, CA (US); Ronald D. Blum, Roanoke, VA (US); Joshua N. Haddock, Roanoke, VA (US); William Kokonaski, Gig Harbor, WA (US); Venkatramani S. Iyer, Roanoke, VA (US)

Correspondence Address: PEARL COHEN ZEDEK LATZER, LLP, 1500 BROADWAY 12TH FLOOR, NEW YORK, NY, 10036, US

(21) Appl. No.: 11/797,210

(22) Filed: May 1, 2007

Related U.S. Application Data
(63) Continuation-in-part of application No. 11/321,324, filed on Dec. 29, 2005.
Application No. 11/321,324 is a continuation of application No. 11/091,104, filed on Mar. 28, 2005, now Pat. No. 7,188,948.
Application No. 11/091,104 is a continuation of application No. 10/626,973, filed on Jul. 25, 2003, now Pat. No. 6,918,670.
Application No. 10/626,973 is a continuation of application No. 09/602,013, filed on Jun. 23, 2000, now Pat. No. 6,619,799.
(63) Continuation-in-part of application No. 11/263,049, filed on Oct. 31, 2005.
(60) Provisional application No. 60/142,053, filed on Jul. 2, 1999.
(60) Provisional application No. 60/143,626, filed on Jul. 14, 1999.
(60) Provisional application No. 60/147,813, filed on Aug. 10, 1999.
(60) Provisional application No. 60/150,545, filed on Aug. 25, 1999.
(60) Provisional application No. 60/150,564, filed on Aug. 25, 1999.
(60) Provisional application No. 60/161,363, filed on Oct. 26, 1999.
(60) Provisional application No. 60/623,947, filed on Nov. 2, 2004.
(60) Provisional application No. 60/659,431, filed on Mar. 9, 2005.
(60) Provisional application No. 60/661,925, filed on Mar. 16, 2005.
(60) Provisional application No. 60/666,167, filed on Mar. 30, 2005.
(60) Provisional application No. 60/667,094, filed on Apr. 1, 2005.
(60) Provisional application No. 60/669,403, filed on Apr. 8, 2005.
(60) Provisional application No. 60/673,758, filed on Apr. 22, 2005.
(60) Provisional application No. 60/674,702, filed on Apr. 26, 2005.
(60) Provisional application No. 60/679,241, filed on May 10, 2005.
(60) Provisional application No. 60/685,407, filed on May 31, 2005.
(60) Provisional application No. 60/687,341, filed on Jun. 6, 2005.
(60) Provisional application No. 60/687,342, filed on Jun. 6, 2005.
(60) Provisional application No. 60/692,270, filed on Jun. 21, 2005.
(60) Provisional application No. 60/796,876, filed on May 3, 2006.

(51) Int. Cl. G02C 5/02

(52) U.S. Cl. 351/132; 351/133

(57) ABSTRACT

A nose bridge for a fashion spectacle lens frame adapted for housing electro-active lenses is presented. The nose bridge may include a body which may further include electronic components. The nose bridge may further include a connecting element for connecting the electronic components with the electro-active lenses for altering optical properties of the electro-active lenses. The nose bridge may be adapted to fit a variety of frame sizes, shapes, and styles as well as lenses of a variety of sizes and shapes.

### CROSS REFERENCE TO RELATED APPLICATIONS

This application claims priority from and incorporates by reference in its entirety provisional application U.S. Ser. No. 60/796,876, titled “Spectacle Frame Bridge Housing Electronics for Electro-Active Spectacle Lenses”, filed on May 32, 2006.

This application is also a continuation-in-part of co-pending U.S. patent application Ser. No. 11/321,324, titled “Ophthalmic Lens for Correcting Non-Conventional Refractive Error”, filed on Dec. 29, 2005, which is hereby incorporated by reference in its entirety and which is, in turn, a continuation of U.S. patent application Ser. No. 11/091,104, titled “System, Apparatus, and Method for Correcting Vision Using an Electro-Active Lens”, filed on Mar. 28, 2005, which is, in turn, a continuation of U.S. patent application Ser. No. 10/626,973, titled “System, Apparatus, and Method for Correcting Vision Using an Electro-Active Lens”, filed on Jul. 25, 2003, which is, in turn, a continuation of U.S. patent application Ser. No. 09/602,013, titled “Optical Lens System With Electro-Active Lens Having Alterably Different Focal Lengths”, filed on Jun. 23, 2000, and which, in turn, claims priority to the following U.S. Provisional Patent Applications:
Ser. No. 60/142,053, titled “Electro-Active Spectacles”, filed Jul. 2, 1999;
Ser. No. 60/143,626, titled “Electro-Active Spectacles”, filed Jul. 14, 1999;
Ser. No. 60/147,813, titled “Electro-Active Refraction, Dispensing, & Eyewear”, filed Aug. 10, 1999;
Ser. No. 60/150,545, titled “Advanced Electro-Active Spectacles”, filed Aug. 25, 1999;
Ser. No. 60/150,564, titled “Electro-Active Refraction, Dispensing, & Eyewear”, filed Aug. 25, 1999; and
Ser. No. 60/161,363, titled “Comprehensive Electro-Active Refraction, Dispensing, & Eyewear” filed Oct. 26, 1999.

This application is also a continuation-in-part of co-pending U.S. patent application Ser. No. 11/263,049, titled “Electro-Active Spectacle and Method of Fabricating Same”, filed on Oct. 31, 2005, which is hereby incorporated by reference in its entirety and which claims priority to the following US. Provisional Patent Applications:
Ser. No. 60/623,947, titled “Electro-Active Spectacle and Method of Fabricating the Same”, filed Nov. 2, 2004;
Ser. No. 60/659,431, titled “Eye Ware with Electro-Active Prisms”, filed Match 9, 2005;
Ser. No, 60/661,925, titled “Electronic Eye Glass Frame Enabler”, filed Mar. 16, 2005;
Ser. No. 60/666,167, titled “Electronic Eyewear”, filed Mar. 30, 2005;
Ser. No. 60/667,094, titled “Advanced Electronic Eyewear”, filed Apr. 1, 2005;
Ser. No. 60/669,403, titled “Advanced Electronic Eyewear”, filed Apr. 8, 2005;
Ser. No. 60/673,758, titled “Advanced Electronic Eyewear”, filed Apr. 22, 2005;
Ser. No. 60/674,702, titled “Advanced Electronic Eyewear”, filed Apr. 26, 2005;
Ser. No. 60/679,241, titled “Combination Dynamic Lens & Fixed Power Lens Spectacles”, filed May 10, 2005;
Ser. No. 60/685,407, titled “Combination Lens System of a Progressive Addition and or Higher Order Collecting Lens & Fixed Power Lens Spectacles”, filed May 31, 2005;
Ser. No. 60/687,341, titled “Combination Lens System Consisting of a Progressive Lens and Electro-Active Lens”, filed Jun. 6, 2005;
Ser. No. 60/687,342, titled “Everyday Fashion Eyewear Comprised of Four Distinct Thin Lenses and a Frame”, filed Jun. 6, 2005; and
Ser. No. 60/692,270, titled “Electro-Active Spectacle and Method of Fabricating the Same”, filed Jun. 21, 2005.

### BACKGROUND OF THE INVENTION

1. Field of the Invention

The present invention relates to a nose bridge for a fashion spectacle lens frame adapted for housing electro-active lenses.

2. Description of the Related Art

Electro-active spectacle lenses make use of electronic components, which may include electronic circuitry, to alter the optical properties of the lenses. These lenses present new challenges in aesthetically packaging and integrating the electronics within a fashionable spectacle lens frame. The invention disclosed herein describes a practical, cost-effective means for integrating the aforementioned electronics within the nose bridge portion of a fashion spectacle lens frame without disturbing the aesthetics of the overall frame design. The invention disclosed herein also describes a means for using the same nose bridge with a variety of frame sizes, shapes, and styles as well as lenses of a variety of sizes and shapes.

### SUMMARY OF THE INVENTION

In an embodiment of the invention a nose bridge for spectacle frames adapted for housing electro-active lenses may include a body which may further include electronic components. The nose bridge may further include a connecting element for connecting the electronic components with the electro-active lenses for altering optical properties of the electro-active lenses. The nose bridge may be adapted for fitting at least one of the following: a plurality of frame sizes, a plurality of frame shapes, a plurality of frame styles, a plurality of lens sizes, and a plurality of lens shapes.

### DESCRIPTION OF THE DRAWINGS

Embodiments of the invention will be understood and appreciated more fully from the following detailed description taken in conjunction with the drawings in which like reference numerals indicate corresponding, analogous or similar elements, and in which:

FIG. 1 shows a complete pair of spectacles comprising an embodiment of a nose bridge portion of a fashion spectacle lens frame for electro-active lenses;

FIG. 2 is a close up view of a first embodiment of a nose bridge portion of a fashion spectacle lens frame for electro-active lenses;

FIG. 3 is a close up view of a second embodiment of a nose bridge portion of a fashion spectacle lens frame for electro-active lenses; and

FIG. 4 is a close up view of a third embodiment of a nose bridge portion of a fashion spectacle lens frame for electro-active lenses

### DESCRIPTION OF THE PREFERRED EMBODIMENT

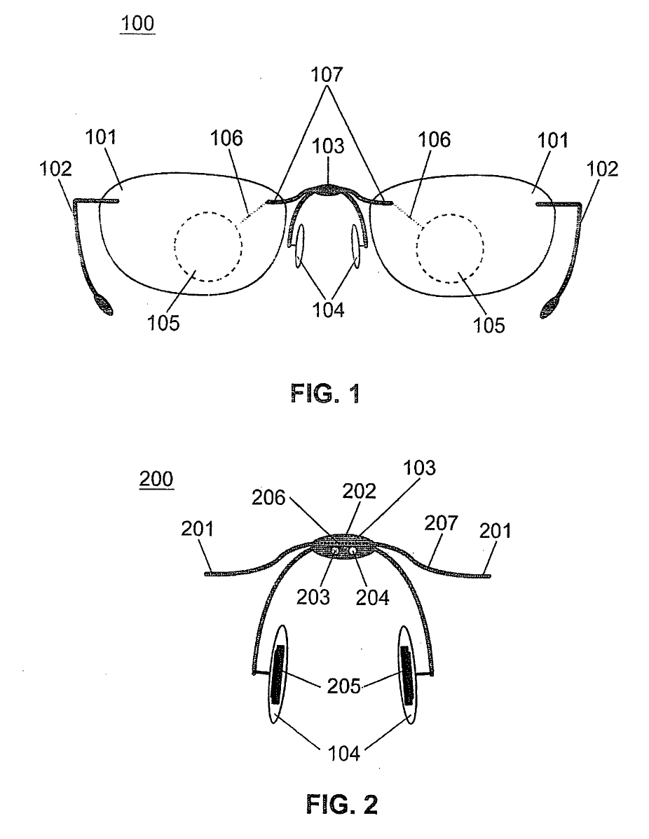

A complete pair of spectacles 100 shown in FIG. 1 comprises two lenses 101, two temple stems 102, and a nose bridge 103, which joins the two lenses together. Nose bridge 103 may also provide for the placement of nose pads 104 to support the spectacles on the wearer's nose. Nose bridge 103 may be adapted to fit a variety of frame types and styles as well as lens shapes and sizes. Electro-active spectacles differ from conventional spectacles in that the optical properties of a portion of the lenses 105 may be dynamically altered by the application of suitable electrical signals. For example, the focal length or optical transmission of the lenses may be changed. These electrical signals ale typically produced by means of electronic components, which may include electronic circuitry, which must be electrically connected to the electro-active portion of the lenses 105 The electrical circuitry and electronic components can include, by way of example only, one or more of the following: a power source, wires, integrated circuits such as drivers and controllers or the like. The electrical circuitry and electronic components can also include additional hardware that enhances the operation of the electro-active spectacles. For example, one or more of the following may be included: a photovoltaic cell, a tilt switch, a light sensor, a passive range-finding device, a time-of-flight range finding device, an eye tracker, a view detector which detects where a user may be viewing, an accelerometer, a proximity switch, a physical switch, a manual override control, a capacitive switch which switches when a user touches the nose bridge or the like.

One method of delivering these electrical signals to the electro-active portion of the lenses 105 is to locate some or all of the electronics within the nose bridge 103. An electrical connection can then be made between the electronics and electrical contacts 107 within nose bridge 103 at the point where the nose bridge 103 connects to the lenses 105. From the electrical contacts 107 the electrical connection may be extended to the electro-active portion of the lenses 105 by means of electrical leads 106 within the lens. Electrical leads 106 may be transparent and may be made out of a transparent conductive material such as Indium Tin Oxide (ITO) or the like.

In a first embodiment of nose bridge 103 shown in FIG. 2, nose bridge 200 is a self-contained unit that is designed to be compatible with many different types of spectacle frames. For example, nose bridge 200 may be used with front eye-wire style spectacle frames and the like. At least a portion of the electronic components and circuitry are concealed within the body 202 of the nose bridge 200. Electrical connection to the electro-active portion of the lenses 105 may be made by means of connecting element 207. Connecting element 207 serves to mechanically and electrically connect the body 202 of nose bridge 200 to lenses 101. Connecting element 207 contains electrical contact points 201, which are located at the points where the bridge connects to lenses 101.

Electro-active lenses may require input from the wearer's environment to operate properly. For example, it may be beneficial to detect the distance to which a wearer is focused by means of a range finding or view detecting device and adjust the optical power of the electro-active portion of the lens 105 accordingly. It may also be beneficial to detect the intensity or level of light and adjust the optical transmission of the electro-active portion of the lens 105 accordingly. The optical transmission of the lens may be altered by means of tinting the lens or other chromatic changes to the lens In this first embodiment a transmitter 203 and a receiver 204 may be mounted to the body of the bridge 202. Transmitter 203 and a receiver 204 may be used to perform range finding such as time-of-flight range finding or passive range finding. Multiple transmitters 203 and/or receivers 204 may also be used. In certain other embodiments, only the transmitter 203 is located on the bridge and the receiver 204 is located on another frame component, such as by way of example only, the temple stems. In other embodiments, only the receiver 204 is located on the bridge and the transmitter 203 is located on another frame component, such as the temple stems. In other embodiments it may be adequate to only receive input from the environment, in which case only a receiver 204 sensitive to the stimulus of interest would be required.

Transmitter 203 and receiver 204 may transmit and receive various types of energy. For example, transmitters and receivers used for range finding may transmit and receive electro-magnetic or acoustic energy. This energy may or may not be within a frequency or wavelength range normally detectably by the human sense organs. For example, infrared light or ultrasonic noise may be used.

Electrical power may be supplied by power source 205 contained within the nose pads 104 connected to bridge body 202. The power source 205 may include, by way of example only, batteries or fuel cells. The power source 205 may be rechargeable, in which case it may be permanently attached to the bridge 200. The power source 205 may also be disposable, in which case it may be easily removed and replaced as needed. Furthermore, the nose pad 104 which contains the power source 205 may be disposable, in which case as power source 205 is consumed it may be replaced by simply replacing the nose pad 104. However, in other embodiments, power source 205 is rechargeable in which case it is no longer necessary to dispose of nose pad 104. Supplemental electrical energy for operation of the electronics or recharging of the power source 205 in situ may be provided by a small photovoltaic allay 206 located on the outside of the main body of the bridge 202.

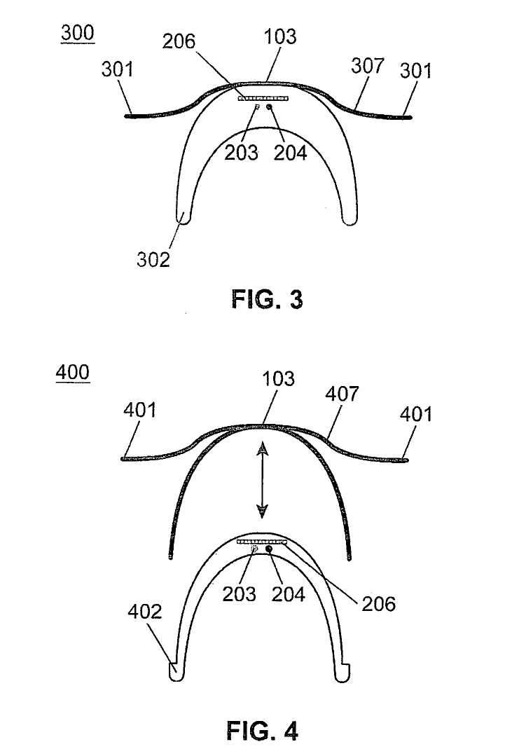

In a second embodiment of nose bridge 103 shown in FIG. 3, nose bridge 300 is primarily comprised of a body 302 which contains at least a portion of the electronic components and circuitry. Body 302 may be molded from an organic resin(s). Electrical connection to the electro-active portion of the lenses 105 is made by means of connecting element 307. Connecting element 307 serves to mechanically and electrically connect the body 302 of nose bridge 300 to lenses 101. Connecting element 307 contains electrical contact points 301, which are located at the points where the bridge connects to lenses 101. Power source 205 may be encapsulated within the bridge body 302 in which case it may be rechargeable. Alternately, body 302 may open to allow the removal and replacement of power source 205. Molded body 302 may contain a transmitter 203 and/or a receiver 204 for sensing the wearer's environment. Molded body 302 may also contain a photovoltaic array 206 for providing extra electrical power or for recharging power source 205 in situ.

In a third embodiment of nose bridge 103 shown in FIG. 4, nose bridge 400 may be comprised of two components The first component, connecting element 407 is permanently attached to the electro-active lenses 101 and frame. The second component, body 402, is similar to the molded body 302 in the second embodiment and contains at least a portion of the electronic components and circuitry. In this embodiment the molded body 402 can be easily attached to and removed from the connecting element 407 using appropriate physical and electrical connectors (not shown).

Electrical connection to the electro-active portion of the lenses 105 is made by means of connecting element 407. Connecting element 407 serves to mechanically and electrically connect the body 402 of nose bridge 400 to lenses 101. Connecting element 407 contains electrical contact points 401, which are located at the points where the bridge connects to lenses 101. The body 402 may contain a non-rechargeable power source 205 and this may be disposable and replaced as the power source 205 is consumed. Alternately, power source 205 may be rechargeable in which case the body 402 may be removed from the connecting element 407 and placed in an appropriate charging unit as needed. Alternately, body 402 may open to allow the removal and replacement of power source 205. Molded piece 402 may contain a transmitter 203 and/or a receiver 204 for sensing the wearer's environment, Molded body 402 may also contain a photovoltaic array 206 for providing extra electrical power or recharging power source 205 in situ. Such an approach would be well suited to the plastic of zyle resin frames where the physical and electrical connectors required for such a design could be more easily incorporated and concealed.

In a fourth embodiment (not shown) of nose bridge 103 an approach such as that illustrated in FIG. 4 may be employed where only the portion of the molded body component that contains the power source 205 can be removed. In such an embodiment the power source 205 may be either disposable or rechargeable as discussed in the third embodiment.

The above embodiments do not require that all of the electronic circuitry and/or components be contained within the nose bridge portion of the frames. In certain other, embodiments other frame components such as the temple stems, temple hinges, and eye wire may be used to mount and conceal electronic components and/or circuitry.

The above embodiments of nose bridge 103 may be adapted to be a common platform for a variety of frames and lenses. Nose bridge 103 may be adapted for fashion spectacle frames of various types, sizes, and styles as well as for frames manufactured from a variety of materials. Nose bridge 103 may be adapted to fit a variety of lenses of different sizes and shapes as well as lenses manufactured from a variety of materials. This may be accomplished by having nose bridge 103 be integrated into the frame or by having nose bridge 103 attach to a portion of an existing frame.

In embodiments in which power source 205 is rechargeable, power source 205 may be recharged within the nose bridge 103. In another embodiment, power source 205 may be detached from nose bridge 103 and recharged outside of nose bridge 103. In embodiments in which power source 205 is charged within nose bridge 103, nose bridge 103 may contain electrical contact points (not shown) which are adapted to fit a charging station. In another embodiment, power source 205 may be inductively charged within nose bridge 103. In one exemplary embodiment, an eyeglass case may be adapted to be an inductive charger suitable for recharging power source 205 within nose bridge 103 In such an embodiment, spectacles 100 may be placed within the eyeglass case and power source 205 may be recharged.

What is claimed is:

1. A nose bridge for spectacle frames adapted for housing electro-active lenses, comprising:
a body comprising electronic components; and
a connecting element for connecting said electronic components with the electro-active lenses for altering optical properties thereof, wherein the nose bridge is adapted for fitting at least one of the group consisting of: a plurality of frame sizes, a plurality of frame shapes, a plurality of frame styles, a plurality of lens sizes, and a plurality of lens shapes.

2. The nose bridge of claim 1, wherein said body is integral with said connecting element.

3. The nose bridge of claim 1, wherein said body is adapted for detachably attaching to said connecting element.

4. The nose bridge of claim 1, wherein said optical property is that of optical transmission.

5. The nose bridge of claim 1, wherein said optical property is that of focal length.

6. The nose bridge of claim 1, wherein said electronic components comprises a power source.

7. The nose bridge of claim 1, wherein said electronic components comprises an integrated circuit.

8. The nose bridge of claim 1, wherein said electronic components comprises a tilt switch.

9. The nose bridge of claim 1, wherein said electronic components comprises a photovoltaic cell

10. The nose bridge of claim 1, wherein said electronic components comprises a transmitter of electro-magnetic energy not within a range of wavelengths visible to a human eye and a receiver for receiving at least a portion of said electro-magnetic energy.

11. The nose bridge of claim 1, wherein said electronic components comprises a transmitter of acoustic energy not within a range of frequencies audible to a human ear and a receiver for receiving a reflection of at least a portion of said acoustic energy.

12. The nose bridge of claim 1, wherein said electronic components comprises a device for determining a distance between a wearer of the spectacles and an object focused upon by said wearer using the spectacles.

13. The nose bridge of claim 1, wherein said body comprises one or more nose pad that contain a power source.

14. The nose bridge of claim 1, wherein said body comprises a power, source that is rechargeable.
